(19) United States
(12) Patent Application Publication
(10) Pub. No.: US 2026/0153780 A1
(43) Pub. Date: Jun. 4, 2026

(54) RECONFIGURABLE QUANTUM INTERFACE

(71) Applicant: Cisco Technology, Inc., San Jose, CA (US)

(72) Inventors: Jiapeng Zhao, Kenmore, WA (US); Hassan Shapourian, San Mateo, CA (US); Eneet Kaur, Somerville, MA (US); Michael John Kilzer, Los Angeles, CA (US); Reza Nejabati, Los Angeles, CA (US)

(21) Appl. No.: 18/952,548

(22) Filed: Nov. 19, 2024

(51) Int. Cl. G02F 1/35; G02F 1/361; G06N 10/40

(52) U.S. Cl. CPC G02F 1/3507; G02F 1/361; G06N 10/40

(57) ABSTRACT

Example embodiments provide a reconfigurable quantum interface (RQI), preferably for quantum networking purposes. The RQI accepts input signals at numerous wavelengths and lineshapes, and converts the input signals to a number of different output wavelengths and lineshapes while retaining quantum properties (e.g., entanglements) of the signals. The RQI provides on-demand conversion to and from arbitrary input and output wavelengths and lineshapes.

### TECHNICAL FIELD

The present disclosure relates to quantum networking.

### BACKGROUND

Various physical platforms typically used in quantum networking require different spectrum and linewidth characteristics. For example, quantum processing units (QPUs) may operate better with near-infrared photons, while signals transmitted through optical networks may work better with telecommunication wavelength photons. However, current approaches only utilize very specific wavelength converters.

### BRIEF DESCRIPTION OF THE DRAWINGS

FIG. 1 is a block diagram of an example quantum network, according to an example embodiment.

FIG. 2 is a block diagram of an example reconfigurable quantum interface (RQI), according to an example embodiment.

FIG. 3 is a flowchart of a method for entangling photons between remote QPUs of a quantum network, according to an example embodiment.

FIG. 4 illustrates entangling photons between remote QPUs of a quantum network based on swapping in an intermediate network node, according to an example embodiment.

FIG. 5 illustrates directly entangling photons between remote QPUs of a quantum network, according to an example embodiment.

FIG. 6 is a flowchart of a method of synchronizing RQIs and quantum switches based on time slots for achieving entanglement over a quantum network, according to an example embodiment.

FIG. 7 is a flowchart of a method of synchronizing RQIs and quantum switches utilizing command queues for achieving entanglement over a quantum network, according to an example embodiment.

FIG. 8 is a flowchart of an example method for generating entanglement via a reconfigurable quantum interface, according to an example embodiment.

FIG. 9 illustrates a hardware block diagram of a computing device configured to perform functions associated with operations discussed herein, according to an example embodiment.

### DETAILED DESCRIPTION

### Overview

Provided herein is a reconfigurable quantum interface (RQI) that accepts input signals at numerous wavelengths and lineshapes, and converts the input signals to a number of different output wavelengths and lineshapes while retaining quantum properties (e.g., entanglements) of the signals.

### Example Embodiments

Example embodiments provide a reconfigurable quantum interface (RQI), preferably for quantum networking purposes. The RQI accepts input signals at numerous wavelengths and lineshapes, and converts the input signals to a number of different output wavelengths and lineshapes while retaining quantum properties (e.g., entanglements) of the signals. The RQI provides on-demand conversion to and from arbitrary input and output wavelengths and lineshapes.

In networks, only photons in the telecommunication band can be transmitted through fiber with low loss. Modern telecommunication infrastructure relies on wavelength-division multiplexing (WDM) in C band to enhance data rate. Accordingly, an example embodiment provides a reconfigurable quantum interface (RQI) that enables on-demand, lossless, transfer of quantum information from an arbitrary wavelength to WDM channels in C band.

Various physics platforms also share very different spectrum bandwidth lineshapes which determines a spectral intensity of the qubit. According to quantum optics, the interaction cross-section of photons and matter qubits is proportional to the Einstein coefficient, the spectral lineshape of the photon, and the matter qubits. Thus, a bandwidth mismatch between qubits in a network leads to a lower interaction rate. An example embodiment provides a reconfigurable quantum interface (RQI) that enables on-demand, lossless, and quantum-information preserving transfer of the spectral lineshape of flying photons (e.g., a shape of an electromagnetic spectrum in proximity of stronger or weaker intensity regions in the spectrum) which match local matter qubits.

A reconfigurable quantum interface (RQI) of an example embodiment combines reconfigurable quantum frequency conversion (RQFC) and reconfigurable quantum lineshape conversion (RQLC). A general goal of RQFC is achieving deterministic, on-demand, coherent conversion of quantum information from one arbitrary frequency (or wavelength) to a desired frequency (or wavelength) of a WDM channel, or vice versa, with unit efficiency and fidelity. The input and output quantum states are identical except for the frequency. The RQI provides on-demand, tuned, and optimized RQFC for an arbitrary input wavelength, WDM channel, and type of entanglement. RQFC usually focuses on bosons, such as photons and phonons. The conversion process is not limited to one step conversion.

A general goal of RQLC is achieving deterministic, on-demand, coherent conversion of quantum information from one arbitrary lineshape to a desired lineshape with unit efficiency and fidelity. The input and output quantum states are identical except for the lineshape. The RQI provides on-demand, tuned, and optimized RQLC for an arbitrary input lineshape.

A quantum frequency converter (QFC) and a quantum lineshape converter (QLC) both employ nonlinear processes. A QFC can be realized by conventional or other /chi 1 (X¹), /chi2 (X²), or /chi 3 (X³) processes. A QLC is mainly achieved by a /chi 2 (X²) or /chi 3 (X³) process. Nonlinear material for the QFC (or QLC) can be buck crystal, photonic chip, or atomic vapor. In nonlinear optics, \chi n represents the n-th order nonlinear process. The \chi1 (X¹) process is a linear process, such as a piezoelectric effect which has been used to coherently transfer microwave photons to optical photons. The \chi2 (X²) process is a second order nonlinear process, which usually involves two input photons to generate one new photon (e.g., sum-frequency and difference frequency generation in PPLN crystal, etc.). The \chi3 (X³) process is a third order nonlinear process involving three input photons as the input and one new photon as the output. Unlike the \chi2 (X²) process, which can only happen in noncentral symmetric material, the \chi3 (X³) process can be found in every material but the strength is usually less than the \chi2 process.

A conventional QFC (or QLC) for single-to-single frequency (lineshape) conversion for a specific entanglement type may be based on a /chi2 (X²) process and includes a strong pump laser and a /chi2 (X²) nonlinear media. However, a QFC (or QLC) based on a /chi1 (X¹) or /chi3 (X³) process is similar. An input qubit at arbitrary frequency (or lineshape) and signals from the strong pump laser are applied to the nonlinear media or material to perform the specific single-to-single frequency conversion and produce an output qubit at a specific WDM frequency (or desired lineshape). However, these devices cannot work for general purpose quantum networks.

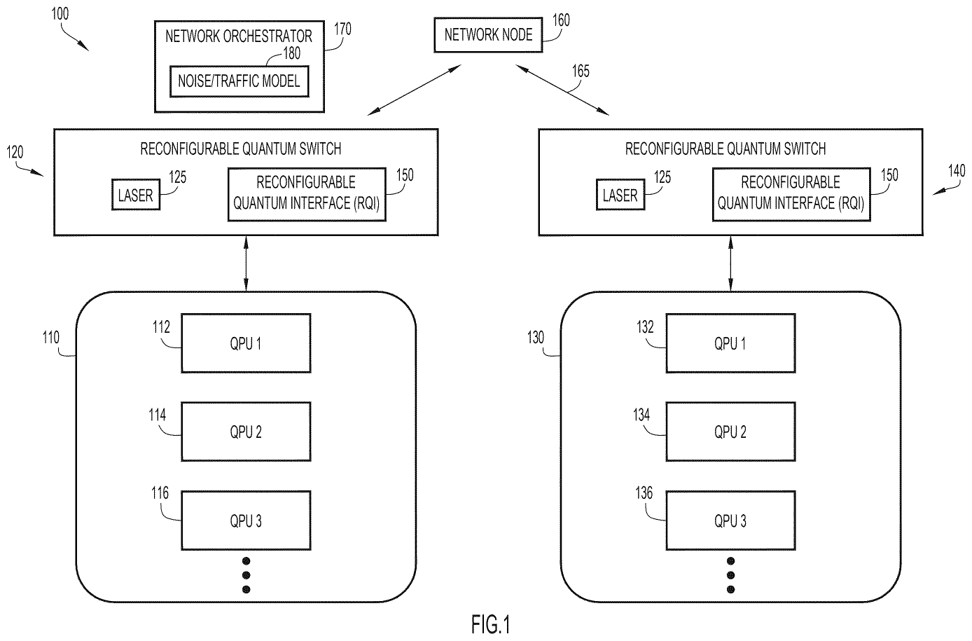

FIG. 1 illustrates an example quantum network 100, according to an example embodiment. Quantum network 100 includes network endpoints 110, 130, reconfigurable quantum switches 120, 140, one or more network nodes 160, and a network orchestrator 170. The components of quantum network 100 may communicate over network links 165. The network links may include optical fibers that may be configured to support telecommunication optical wavelengths and techniques, such as wave-division multiplexing (WDM) communications centered at wavelengths of 1550 nm. The network links may provide for a Full Scale Range (FSR) of 100 GHz, 0-2 dbm for each channel, and include around 40-50 channels in a network link. The network links may be embodied as pre-existing classical infrastructure that are also used to provide and obtain classical communication signals in quantum network 100. Since optical fibers are capable of supporting a wide range of wavelengths and a large number of optical channels, it may be possible to have quantum signals and classical signals coexisting in the same optical fiber. For example, classical communications within a specific channel may be limited to a particular wavelength band for a particular application, leaving the other bands available for use by quantum applications. However, quantum network 100 may include any topology with any quantity of network components.

By way of example, network endpoint 110 includes QPUs 112, 114, and 116 (e.g., QPU1, QPU2, QPU3, etc.), while network endpoint 130 includes QPUs 132, 134, 136 (e.g., QPU1, QPU2, QPU3, etc.). However, the network endpoints may include any quantity of QPUs. The QPUs of network endpoint 110 are coupled to reconfigurable quantum switch 120 employing a laser 125 and a reconfigurable quantum interface (RQI) 150 of example embodiments described below. The QPUs of network endpoint 130 are coupled to a reconfigurable quantum switch 140 that is substantially similar to reconfigurable quantum switch 120. Each reconfigurable quantum switch 120, 140 is coupled to a network node 160. Network node 160 may perform entanglement, routing, and/or other operations for distributed entanglement between QPUs of network endpoints 110, 130 as described below.

Network orchestrator 170 controls configuration of components of quantum network 100 (e.g., reconfigurable quantum switches 120, 140, network node 160, etc.) to perform desired operations (e.g., distribute entanglement between QPUs, etc.). Network orchestrator 170 includes a noise/traffic model 180 to generate parameters for configuring the components of quantum network 100 based on noise and/or traffic in the quantum network. For example, the dynamics of optical fields, or the quantum state of photons, in an optical fiber is governed by the nonlinear Schrodinger equation. Many major fiber noise models can be found by solving the nonlinear Schrodinger equation. These noise spectra are often incoherent, meaning the spectra are independent to each other.

Therefore, the noise/traffic model may estimate the noise spectra of each incoherent noise individually, and then combine the noise spectra to model incoherent noise sources. For example, noise/traffic model 180 may be used to generate a plurality of noise spectra that indicate the noise generated in an optical channel by classical communication signals in the optical channel. A combined noise spectrum is generated by combing the plurality of noise spectra. A quantum channel parameter is determined for a quantum signal from the combined noise spectrum. The quantum channel parameter may be one of numerous parameters. Example parameters include the wavelength, polarization and/or photon number/intensity to be used for the quantum signal, a degree of freedom for entanglement of the quantum signal, an encoding protocol for the quantum signal, swap type, among others. The parameter determined may be selected based on a metric required for an application associated with the quantum signal. By way of example, a quantum channel may be selected to be in a wavelength range. This would be a first channel parameter selected, and the above techniques may be repeated using other noise models to determine other channel parameters.

Optical fibers, however, may also exhibit coherent noise, which usually do not have analytical forms because the nonlinear Schrodinger equation that describes coherent noise is difficult to solve. Accordingly, noise/traffic model 180 may employ a neural network to dynamically determine the parameters for quantum signals provided over optical links shared with classical signals. Furthermore, as more classical channels are combined, coherent noise, which may be too complicated to determine through pre-existing models, may significantly contribute to channel noise. Thus, a combined noise spectrum generated from classical incoherent noise models may not be comprehensive at some phases.

In order to model spectra that include both coherent and incoherent sources of noise, noise/traffic model 180 may employ physics-informed neural networks (PINNs). A PINN is a supervised neural network whose training is guided by physical laws. PINNs may more efficiently and more accurately predict, for example, an optical channel noise spectrum because the implementation of physics equations into the loss function of the neural network filters out the non-physical results. Moreover, a PINN may be able to solve physics equations, such as nonlinear Schrodinger equations, that are very difficult to solve using other techniques. Implementing PINNs may enable noise/traffic model 180 to predict coherent channel spectra noise when using incoherent noise models to train the PINN. Therefore, by using the PINN and the appropriate nonlinear Schrodinger equation, noise/traffic model 180 may be used to generate a comprehensive noise spectrum including both incoherent and coherent noise.

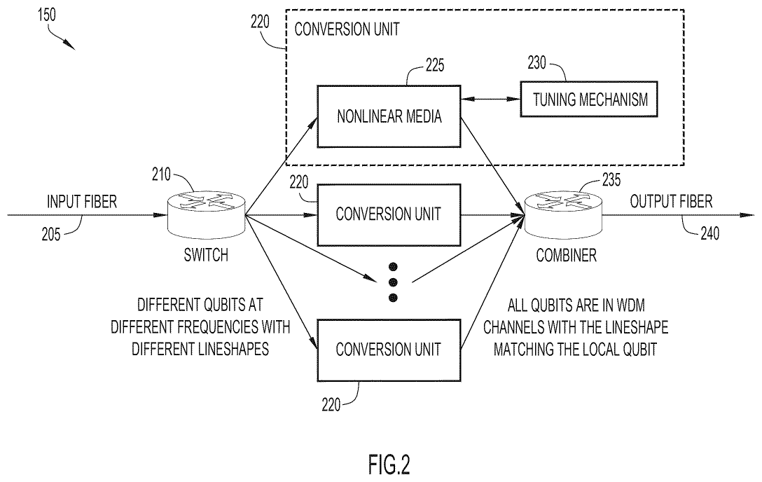

With continued reference to FIG. 1, FIG. 2 illustrates a block diagram of a reconfigurable quantum interface (RQI), according to an example embodiment. RQI 150 includes input fiber 205, a quantum switch 210, conversion units 220, a combiner 235, and output fiber 240. Input fiber 205 provides input qubits to RQI 150, and is coupled to quantum switch 210. Quantum switch 210 directs the input qubit to the appropriate conversion unit 220 for conversion to the desired output frequency (and/or lineshape), while combiner 235 provides the results from conversion units 220 to WDM channels and directs the signals to output fiber 240.

Conversion units 220 each include nonlinear media 225 and a tuning mechanism 230. Nonlinear media 225 (or nonlinear material) is designed to cover a wide bandwidth (both frequency bandwidth and lineshape compression bandwidth), and is associated with a corresponding tuning mechanism 230. RQI 150 includes multiple nonlinear material for more bandwidth (both frequency bandwidth and lineshape compression bandwidth) and entanglement coverage. Nonlinear media 225 may include any quantity of nonlinear media or materials (e.g., one or more nonlinear mediums or materials, etc.).

Nonlinear media 225 are configured to enable each conversion unit 220 to cover a corresponding range of spectrum, lineshape, and entanglement, thereby enabling RQI 150 to cover all desired bands, lineshapes, and types of entanglement for a series of different WDM channels. RQI 150 may include any quantity of conversion units to cover desired bandwidths, lineshapes, and types of entanglement for any quantity of WDM or other channels.

The configuration for nonlinear media 225 is obtained by selecting a quasi-phase matching scheme and designing the poling period for a larger covered spectral bandwidth and linewidth compression bandwidth. Preferably, a crystal with a long length is selected to accommodate the narrow linewidth nature of the qubits and enhance the efficiency. Nonlinear media 225 are selected to enable conversion units 220 to cover all desired bandwidths, and preferably have a large nonlinear coefficient and tunability, a high damage threshold for higher conversion efficiency, and/or high purity to reduce noise.

Nonlinear media 225 are not limited to mineral or metallic materials (e.g., lithium niobate (LN) or potassium titanyl phosphate (KTP)), but may employ any organic crystals. For example, RQI 150 may convert a polarization entangled photon emitted by a rubidium (Rb) atom to dense wavelength-division multiplexing (DWDM) bands. In this case, a crystal needs to transfer a 780 nm photon to a 1550 nm photon. A \chi 2 process may be selected as the nonlinear process to leverage. Even though it is a noisier process than the \chi3 process, the technology is more mature and better engineered. Periodically Poled Lithium Niobate (PPLN) is the preferred candidate for crystal LN since it is a very efficient nonlinear material with a strong \chi2 coefficient, and PPLN is more flexible in design and operation for polarization entangled photons. In order to reconfigure the wavelength into different DWDM channels, the phase matching condition in the PPLN needs to be reconfigured. Thermal tuning is preferably employed as it is most mature and perfectly aligned with the poling in the PPLN. In order to maximize conversion efficiency, the poling period can be carefully designed to maximize the phase matching bandwidth, and a careful design can provide a 3 dB bandwidth of more than 80 nm in the C band.

In an embodiment, tuning mechanism 230 uses a combination of thermal tuning and a second tuning technique including stress or electro-optical (EO) tuning. Thermal tuning is employed for coarse tuning and has the most maturity, a high tuning range, and good uniformity. However, thermal tuning provides slow speed, moderate control accuracy, and reduced reliability. Thermal tuning is typically achieved using a fine tuned heat sink.

Stress or EO tuning is employed for fine tuning. Stress tuning provides fast tuning, a moderate tuning range, and precise control. However, stress tuning provides moderate uniformity and possible permanent damage. Stress tuning is typically achieved using piezoelectric actuators and membranes. EO tuning provides fast tuning and precise control. However, the tuning range is limited by the nonlinear coefficient and the applied voltage. A large tuning range is typically achieved by high voltage modulators, which may lead to permanent damage as well. EO tuning is not supported by all materials, and voltage-induced thermal drifting may occur, leading to thermal-EO coupled tuning noise.

For example, the thermal and EO tuning may be combined or integrated by designing a thermal stage (or heat sink) with a lithium niobate (LN) modulator on top of it. The thermal stage is heated to shift a refractive index of the LN in a broad but coarse range. Voltage is added to the LN by the modulator to control the refractive index within a narrower range but in a precise way. By way of example, the tuning mechanism may provide MHz tuning speed between two arbitrary WDM channels within a selected band without introducing thermal-EO coupled tuning noise.

The limitations of nonlinear materials do not allow one material to cover all desired bandwidths even with tuning. Accordingly, a combination of multiple nonlinear materials (or nonlinear media 225) is selected for conversion units 220 to enable the conversion units to collectively to cover all desired bandwidths. Thus, each conversion unit 220 is associated with a corresponding range of spectrum, lineshape, and entanglement. For example, nonlinear media 225 of conversion units 220 may include Nitrogen-vacancy color center in diamond (e.g., NV for a wavelength of 637 nm), Silicon-vacancy color center in diamond (e.g., SiV for a wavelength of 737 nm), rubidium (e.g., ⁸⁷Rb for a wavelength of 780 nm), calcium (e.g., ⁴⁰Ca⁺ for wavelengths of 854 nm), and barium (e.g., ¹³⁸Ba⁺ for wavelengths of 493 nm). Further, the desired WDM channels may be separated by 50 or 100 GHz centered at 1550 nm. In addition, the bandwidth for RQI 150 may exceed 10 THz at 1550 nm (e.g., greater than 100 WDM channels).

Input fiber 205 provides input qubits to RQI 150, and is coupled to quantum switch 210. The input qubits may have different frequencies and lineshapes. Quantum switch 210 (e.g., a WDM-like passive switch) directs or switches input qubits to the appropriate conversion unit 220 based on the frequency for conversion to the desired output frequency (or lineshape). Combiner 235 combines the resulting qubits for corresponding WDM channels. The resulting output qubits are all in WDM channels with the lineshape matching the local qubit (e.g., of the destination) and are directed from combiner 235 to output fiber 240.

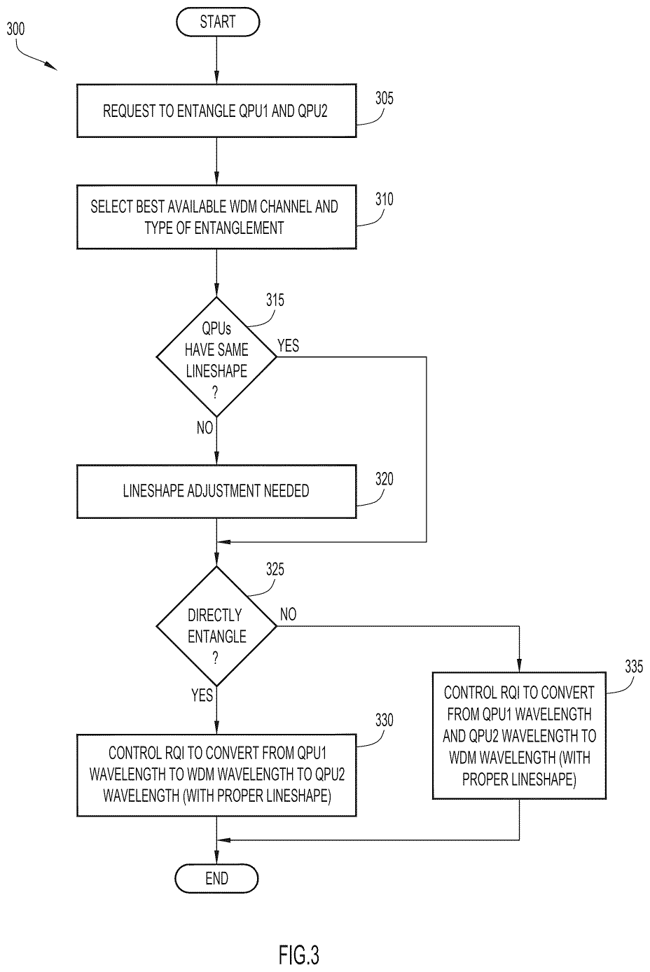

With continued reference to FIGS. 1 and 2, FIG. 3 is a flowchart of a method 300 for entangling photons between remote QPUs of a quantum network, according to an example embodiment. By way of example, method 300 is described with respect to generating entanglement between QPUs within quantum network 100 (FIG. 1), but may be used to generate entanglement between any components in any quantum network in substantially the same manner described below.

Initially, a request is received to entangle two QPUs with wavelengths lambda1 (λ1) and lambda2 (λ2) at two different network locations or endpoints at operation 305. By way of example, entanglement may be requested between QPU 112 (QPU1) of network endpoint 110 and QPU 134 (QPU2) of network endpoint 130. However, entanglement between any QPUs or other components of a quantum network may be generated in substantially the same manner described below.

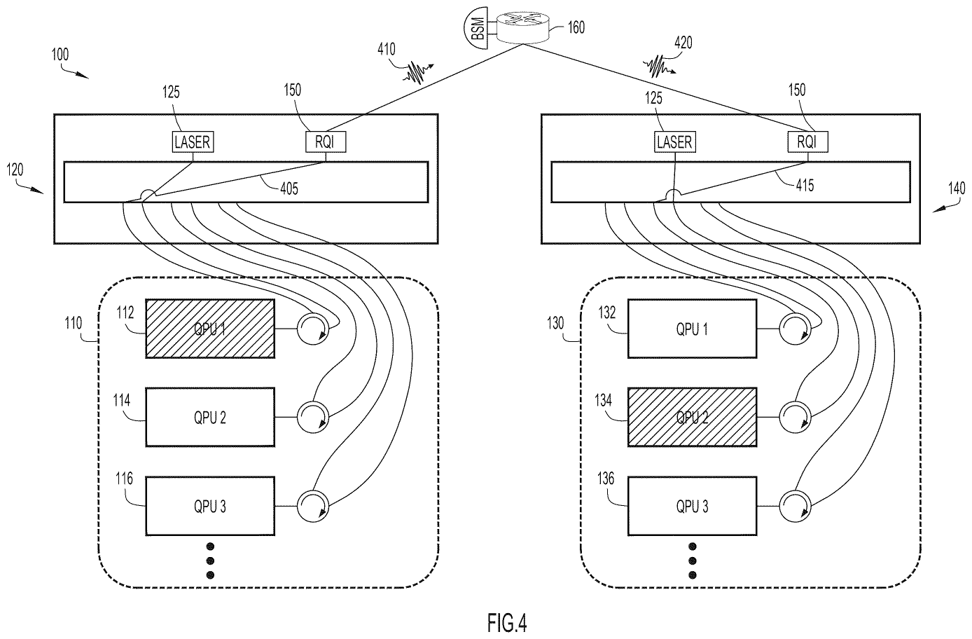

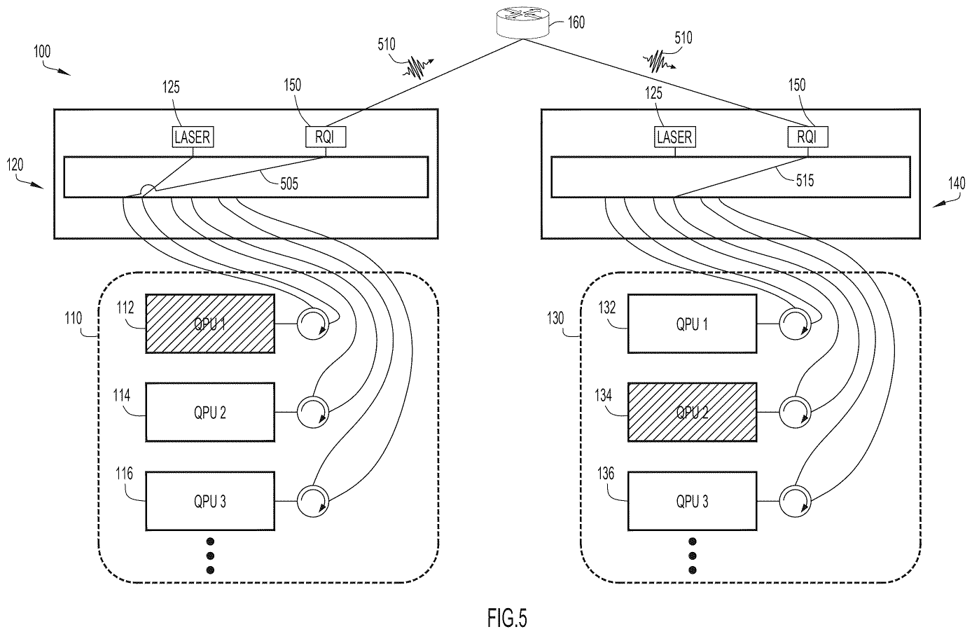

Available WDM channels in quantum network 100 are determined, and the best available WDM channel and type of entanglement are selected at operation 310 based on network orchestrator 170. In addition, the type of swapping is determined (e.g., direct entanglement or entanglement via network node 160). A middle swap type (or entanglement via network node 160) converts wavelengths of QPUs to the wavelength of the WDM channel for entanglement in network node 160 as described below (FIG. 4). A serial swap (or direct entanglement) converts wavelength of a first QPU to a wavelength of the WDM channel and from the wavelength of the WDM channel back to a wavelength of second QPU for direct entanglement as described below (FIG. 5). The selection of the WDM channel, type of entanglement, and type of swap may be based on noise/traffic model 180.

The lineshape for the two QPUs are determined and compared. When the two QPUs do not share the same lineshape as determined at operation 315, a need for alignment of the lineshapes of the photons of the QPUs (e.g., QPU1 of network endpoint 110 and QPU2 of network endpoint 130) is indicated at operation 320. If the lineshape of photons from QPU1 and QPU2 are not ideal, a third lineshape, the ideal lineshape of the channel, may be selected as the desired lineshape function to be converted towards.

When direct entanglement is to be performed as determined at operation 325 (e.g., based on the indication), RQI 150 of reconfigurable quantum switches 120, 140 is controlled (e.g., by sending commands from network orchestrator 170) to tune parameters to convert lambda1 (λ1) of QPU1 to the wavelength for the selected WDM channel and subsequently convert this WDM frequency back to lambda 2 (λ2) for QPU2 at operation 330. The parameters may further be tuned to convert the lineshape when needed.

When entanglement is to be generated by node 160 (e.g., swap in the middle) as determined at operation 325, RQI 150 of the reconfigurable quantum switches is controlled (e.g., by sending commands) to tune parameters to optimize the conversion from lambda1 (λ1) of QPU1 and lambda2 (λ2) of QPU2 to the wavelength/frequency of the selected WDM channel at operation 335. The parameters may further be tuned to convert the lineshape when needed. The converted photons of QPU1 and QPU2 are provided to network node 160 to perform the entanglement.

With continued reference to FIGS. 1-3 , FIG. 4 illustrates entangling photons between remote QPUs of a quantum network based on swapping in an intermediate network node, according to an example embodiment. By way of example, the entanglement of photons is described with respect to entanglement between QPUs within quantum network 100 (FIG. 1), but entanglement may be generated between any components in any quantum network in substantially the same manner described below.

An example scenario utilizes network node 160 for generating entanglement. Initially, local QPU 112 (QPU1) of network endpoint 110 emits a photon 405 based on signals from laser 125 of reconfigurable quantum switch 120. Remote QPU 134 (QPU2) of network endpoint 130 emits a photon 415 with a different wavelength based on signals from laser 125 of reconfigurable quantum switch 140. The wavelength of photon 410 from QPU 112 is converted to produce a photon 410 with a wavelength of a WDM channel by RQI 150 of reconfigurable quantum switch 120 in substantially the same manner described above. Similarly, the wavelength of photon 415 from QPU 134 is converted to produce a photon 420 with a wavelength of the WDM channel by RQI 150 of reconfigurable quantum switch 140.

The converted photons 410, 420 in the same WDM channel are provided to network node 160 that swaps (or entangles) the photons to entangle QPU 112 (QPU1) of network endpoint 110 and QPU 134 (QPU2) of network endpoint 130. Since the QPUs are of the same type for the example scenario, no lineshape adjustment is required.

With continued reference to FIGS. 1-4 , FIG. 5 illustrates directly entangling photons between remote QPUs of a quantum network, according to an example embodiment. By way of example, the entanglement of photons is described with respect to entanglement between QPUs within quantum network 100 (FIG. 1), but entanglement may be generated between any components in any quantum network in substantially the same manner described below.

Another example scenario is a serial swap. In this case, local QPU 112 (QPU1) of network endpoint 110 emits a photon 505 based on a signal from laser 125 of reconfigurable quantum switch 120. The wavelength of photon 505 is converted to produce a photon 510 with a wavelength of a WDM channel by RQI 150 of reconfigurable quantum switch 120 in substantially the same manner described above.

Photon 510 is directed to network node 160 that routes the photon to QPU 134 (QPU2) of network endpoint 130. The wavelength of photon 510 is further converted from the WDM channel wavelength to produce a photon 515 with a wavelength compatible for QPU 134 (QPU2) of network endpoint 130 by RQI 150 of reconfigurable quantum switch 140 in substantially the same manner described above. Photon 515 swaps (or entangles) with a photon of QPU 134 (QPU2) of network endpoint 130 to entangle QPU 112 (QPU1) and QPU 134 (QPU2). Since the QPUs are of the same type for the example scenario, no lineshape adjustment is required.

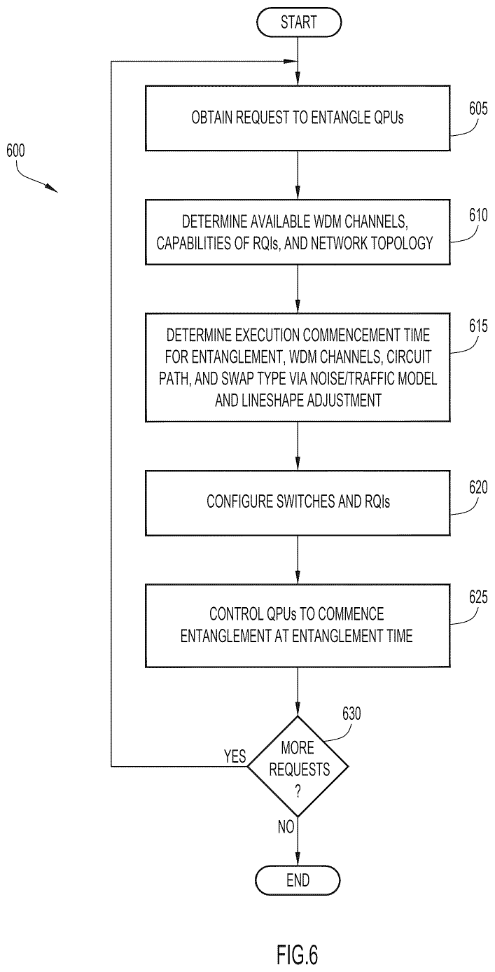

With continued reference to FIGS. 1-5, FIG. 6 illustrates a method 600 of synchronizing QPUs, RQIs, and quantum switches based on time slots for achieving entanglement over a quantum network, according to an example embodiment. By way of example, method 600 is described with respect to quantum network 100 (FIG. 1), but may be used for components in any quantum network in substantially the same manner described below.

Initially, network orchestrator 170, a priori, knows the QPUs in quantum network 100, the network topology, the capabilities of the RQIs, and available WDM channels. Commands are communicated over a classical interconnect network.

Network orchestrator 170 receives a request to entangle QPUs of quantum network 100 with wavelengths lambda1 (λ1) and lambda2 (λ2) at operation 605. By way of example, entanglement may be requested between QPU 112 (QPU1) of network endpoint 110 and QPU 134 (QPU2) of network endpoint 130. However, entanglement between any QPUs or other components may be generated in substantially the same manner described below.

Network orchestrator 170 checks its list of available WDM channels in quantum network 100, the capabilities of the RQIs, and the network topology at operation 610. The network topology may be reconfigurable and change over time. The list of available WDM channels, RQI capabilities, and network topology is provided to noise/traffic model 180 of network orchestrator 170 to determine an execution commencement time for the entanglement, WDM channels to use, a circuit path, and a swap type (e.g., middle or serial) at operation 615. Network orchestrator 170 also determines if a lineshape adjustment is needed. When photons have different lineshapes, an optimal lineshape is chosen to be converted to. A middle swap type converts wavelengths lambda1 (λ1) and lambda2 (λ2) to the wavelength of the WDM channel for entanglement in network node 160 as described above (FIG. 4). A serial swap converts wavelength lambda1 (λ1) to a wavelength of the WDM channel and from the wavelength of the WDM channel back to wavelength lambda2 (λ2) for direct entanglement as described above (FIG. 5).

Network orchestrator 170 controls or configures optical switches needed to complete the circuit between the two QPUs at operation 620 (e.g., reconfigurable quantum switches 120, 140). Once configured, the optical switches communicate their status to network orchestrator 170. Concurrently, RQIs 150 of reconfigurable quantum switches 120, 140 are configured to select the appropriate conversion unit 220 with desired characteristics (spectrum, entanglement type) for conversion to a particular WDM channel, add lineshape adjustment, if needed, and initiate nonlinear media tuning, using tuning mechanism 230. Coarse tuning is performed first via thermal tuning and is declared complete when the refractive index stabilizes to within a certain coarse range. This is followed by fine tuning via stress or EO tuning and is declared complete when the refractive index stabilizes to within a certain fine range. When configuration and tuning are complete, RQIs 150 communicate their status to network orchestrator 170. Other hardware components may be configured in substantially the same manner described above.

Network orchestrator 170 controls (e.g., sends a command to) QPUs 112, 134 to commence entanglement generation at the determined time at operation 625. Alternatively, network orchestrator 170 may send a command to the QPUs with the time within the time slot at which entanglement generation should commence. In a subsequent step, the QPUs would commence entanglement generation at the specified time. When entanglement is achieved or abandoned (e.g., due to an end of a time slot), the above process is repeated from operation 605 for the next time slot until the requests are processed as determined at operation 630. Network orchestrator 170 also communicates entanglement success/failure to QPUs 112, 134.

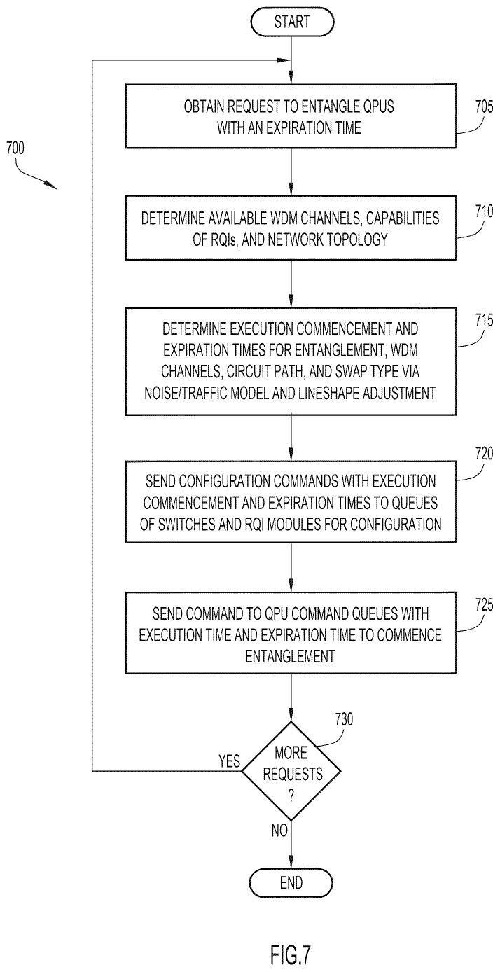

With continued reference to FIGS. 1-6 , FIG. 7 illustrates a method 700 of synchronizing QPUs, RQIs, and quantum switches utilizing command queues for achieving entanglement over a quantum network, according to an example embodiment. By way of example, method 700 is described with respect to quantum network 100 (FIG. 1), but may be used for components in any quantum network in substantially the same manner described below.

Initially, network orchestrator 170, a priori, knows the QPUs in quantum network 100, the network topology, the capabilities of the RQIs, and available WDM channels. Commands are communicated over a classical interconnect network.

Network orchestrator 170 receives a request with an expiration time to entangle QPUs of quantum network 100 having wavelengths lambda1 (λ1) and lambda2 (λ2) at operation 705. By way of example, entanglement may be requested between QPU 112 (QPU1) of network endpoint 110 and QPU 134 (QPU2) of network endpoint 130. However, entanglement between any QPUs or other components may be generated in substantially the same manner described below. The request is placed into a queue of network orchestrator 170 for processing. The request is discarded if the request is processed from the queue at or after the expiration time.

When the request is processed, network orchestrator 170 checks its list of available WDM channels in quantum network 100, the capabilities of the RQIs, and the network topology at operation 710. The network topology may be reconfigurable and change over time. The list of available WDM channels, RQI capabilities, and network topology is provided to noise/traffic model 180 of network orchestrator 170 to determine execution commencement and expiration times for the entanglement (the traffic/noise model also takes into account the expiration time of the request), WDM channels to use, a circuit path, and the swap type (e.g., middle or serial) at operation 715. Network orchestrator 170 also determines if a lineshape adjustment is needed. When photons have different lineshapes, an optimal lineshape is chosen to be converted to. A middle swap type converts wavelengths lambda1 (λ1) and lambda2 (λ2) to the wavelength of the WDM channel for entanglement in network node 160 as described above (FIG. 4). A serial swap converts wavelength lambda1 (λ1) to a wavelength of the WDM channel and from the wavelength of the WDM channel back to wavelength lambda2 (λ2) for direct entanglement as described above (FIG. 5).

Network orchestrator 170 controls or configures optical switches (e.g. by queuing up commands with commencement and expiration times) needed to complete the circuit between the two QPUs (e.g., reconfigurable quantum switches 120, 140). Network orchestrator 170 sends configuration commands with execution commencement and expiration times to queues for reconfigurable quantum switches 120, 140 and queues for RQIs 150 at operation 720. The expiration time enables devices to clear the commands from their queues without intervention of network orchestrator 170. The execution commencement times are at a certain amount of time before commencement of entanglement generation to provide reconfigurable quantum switches 120, 140 and RQIs 150 time to configure. At the execution commencement time, RQIs 150 are directed to select the appropriate conversion unit 220 with desired characteristics (spectrum, entanglement type) for conversion to a particular WDM channel, add lineshape adjustment, if needed, and initiate nonlinear media tuning, using tuning mechanism 230. Coarse tuning is performed first via thermal tuning and is declared complete when the refractive index stabilizes to within a certain coarse range. This is followed by fine tuning via stress or EO tuning and is declared complete when the refractive index stabilizes to within a certain fine range. When configuration and tuning are complete, RQIs 150 communicate their status to network orchestrator 170. The optical switching (e.g., reconfigurable quantum switches 120, 140, etc.) are also configured and communicate their status to network orchestrator 170 at the execution commencement time. Other hardware components may be configured in substantially the same manner described above. Concurrently, network orchestrator 170 sends a command to the command queues of QPUs 112, 134 with an execution time to commence entanglement and expiration time (so QPUs can clear the command from their queues without intervention of network orchestrator 170) at operation 725.

When entanglement is achieved or abandoned (e.g., due to an expiration time being reached), the above process is repeated from operation 705 for the next command in the queue until the requests are processed as determined at operation 730. Network orchestrator 170 also communicates entanglement success/failure to QPUs 112, 134.

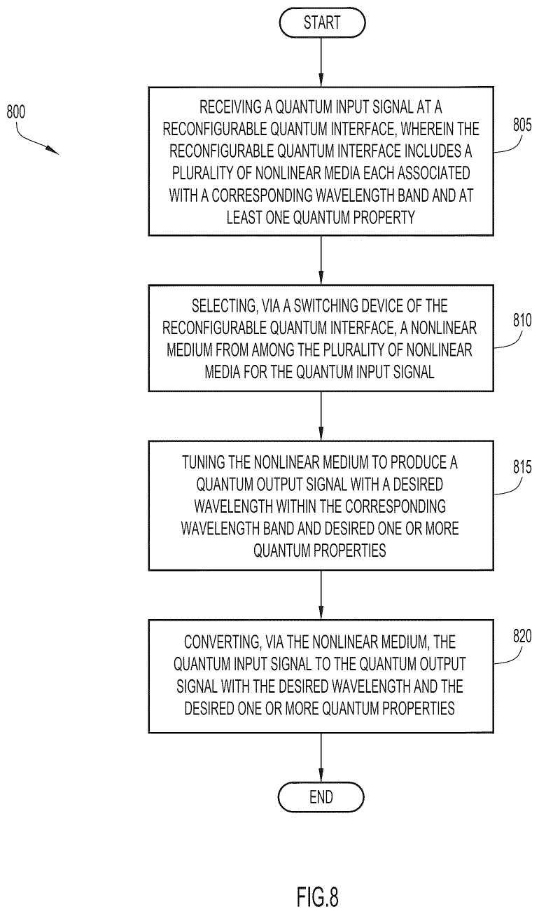

FIG. 8 is a flowchart of an example method 800 for generating entanglement via a reconfigurable quantum interface, according to an example embodiment. At operation 805, a quantum input signal is received at a reconfigurable quantum interface. The reconfigurable quantum interface includes a plurality of nonlinear media each associated with a corresponding wavelength band and at least one quantum property. At operation 810, a switching device of the reconfigurable quantum interface selects a nonlinear medium from among the plurality of nonlinear media for the quantum input signal. At operation 815, the nonlinear medium is tuned to produce a quantum output signal with a desired wavelength within the corresponding wavelength band and desired one or more quantum properties. At operation 820, the nonlinear medium converts the quantum input signal to the quantum output signal with the desired wavelength and the desired one or more quantum properties.

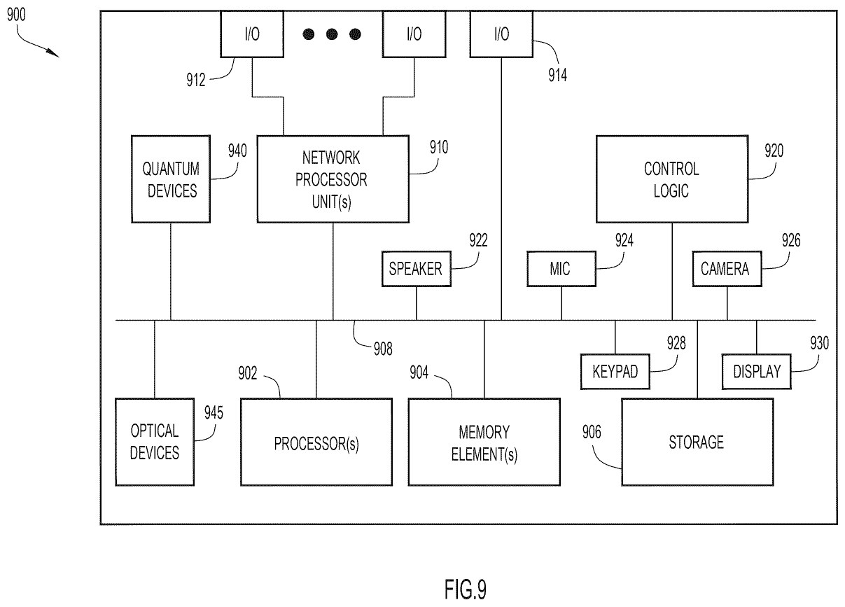

Referring to FIG. 9, FIG. 9 illustrates a hardware block diagram of a computing device 900 that may perform functions associated with operations discussed herein in connection with the techniques depicted in FIGS. 1-8 . In various embodiments, a computing device or apparatus or system, such as computing device 900 or any combination of computing devices 900, may be configured as any device entity/entities (e.g., network nodes, computer devices, user devices, client devices, communication devices, network devices, processors, switching devices, network interfaces, controller, quantum nodes, network orchestrator, etc.) as discussed for the techniques depicted in connection with FIGS. 1-8 in order to perform operations of the various techniques discussed herein.

In at least one embodiment, computing device 900 may be any apparatus that may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory elements 904 (or vice versa), or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interfaces 912 may include suitable interfaces for receiving, transmitting, and/or otherwise communicating data and/or information in a network environment.

I/O interface(s) 914 allow for input and output of data and/or information with other entities that may be connected to computing device 900. For example, I/O interface(s) 914 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

With respect to certain entities (e.g., client device, network device, network nodes, processors, network interfaces, switching devices, quantum nodes, etc.), computing device 900 may further include, or be coupled to, a speaker 922 to convey sound, microphone or other sound sensing device 924, camera or image capture device 926, a keypad or keyboard 928 to enter information (e.g., alphanumeric information, etc.), a touch screen or other display 930, quantum devices 940, and/or optical devices 945. These items may be coupled to bus 908 or I/O interface(s) 914 to transfer data with other elements of computing device 900. Quantum devices 940 may include any conventional or other devices to perform the functions described herein (e.g., generating, transmitting, receiving, entangling, and/or processing quantum signals and/or keys), such as a quantum source, quantum transmitters and receivers, quantum channels, a source of randomness, lasers or other energy sources, quantum measuring devices, quantum logic or other gates or circuits, quantum memories, quantum processing units, quantum buffers, switches, etc. Optical devices 945 may include any conventional or other optical devices to perform the functions described herein (e.g., generating, transmitting, receiving, and/or processing classical or other optical signals), such as optical switches, optical transmitters and receivers, optical multiplexers or other switching devices, etc.

In various embodiments, control logic 920 can include instructions that, when executed, cause processor(s) 902 to perform operations, which can include, but not be limited to, providing overall control operations of computing device 900; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, network devices, storage devices, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various network devices, storage devices, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, any device entity or apparatus as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more device entities as discussed herein could be provided in any database, table, register, list, cache, storage, and/or storage structure: all of which can be referenced at any suitable timeframe. Any such storage options may also be included within the broad term ‘memory element’as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory elements 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ or ‘frame’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4(IPv4 ) and/or IP version 6(IPv6 ) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more device entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combinations of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided. The method comprises: receiving a quantum input signal at a reconfigurable quantum interface, wherein the reconfigurable quantum interface includes a plurality of nonlinear media each associated with a corresponding wavelength band and at least one quantum property; selecting, via a switching device of the reconfigurable quantum interface, a nonlinear medium from among the plurality of nonlinear media for the quantum input signal; tuning the nonlinear medium to produce a quantum output signal with a desired wavelength within the corresponding wavelength band and desired one or more quantum properties; and converting, via the nonlinear medium, the quantum input signal to the quantum output signal with the desired wavelength and the desired one or more quantum properties.

In one example, the desired wavelength of the quantum output signal corresponds to a wavelength for a wave-division multiplexing channel for a quantum network, and the at least one quantum property includes entanglement.

In one example, the at least one quantum property further includes a lineshape.

In one example, a combined wavelength band for the plurality of nonlinear media includes bandwidths for a series of different wave-division multiplexing channels of a quantum network.

In one example, tuning the nonlinear medium uses a combination of thermal tuning and a second tuning technique including one of stress tuning and electro-optical tuning.

In one example, the thermal tuning tunes the nonlinear medium in a coarse range, and the second tuning technique tunes the nonlinear medium in a narrower range with a higher tuning resolution.

In one example, the nonlinear medium includes mineral or metallic materials.

In one example, the nonlinear medium includes organic crystals.

In one example, the quantum input signal is received from a quantum processor of a quantum network, and the method further comprises: converting, via a second reconfigurable quantum interface, a second quantum input signal from a second quantum processor of the quantum network to a second quantum output signal with the desired wavelength and the desired one or more quantum properties; sending the quantum output signal and the second quantum output signal to a network node of the quantum network; and entangling the quantum processor and the second quantum processor at the network node based on the quantum output signal and the second quantum output signal, wherein the reconfigurable quantum interface, the second reconfigurable quantum interface, the quantum processor, the second quantum processor, and optical switches of the quantum network are synchronized utilizing one of time slots and command queues.

In one example, the quantum input signal is received from a quantum processor of a quantum network, and the method further comprises: routing, via a network node of the quantum network, the quantum output signal to a second quantum processor; converting, via a second reconfigurable quantum interface, the quantum output signal to a second quantum output signal with a wavelength and one or more quantum properties compatible with the second quantum processor; and entangling the quantum processor and the second quantum processor based on the second quantum output signal, wherein the reconfigurable quantum interface, the second reconfigurable quantum interface, the quantum processor, the second quantum processor, and optical switches of the quantum network are synchronized utilizing one of time slots and command queues.

In another form, an apparatus is provided. The apparatus comprises a reconfigurable quantum interface including: a plurality of nonlinear media each associated with a corresponding wavelength band and at least one quantum property; a switching device to select a nonlinear medium from among the plurality of nonlinear media for a quantum input signal; and a tuning mechanism to tune the nonlinear medium to convert the quantum input signal to a quantum output signal with a desired wavelength within the corresponding wavelength band and desired one or more quantum properties.

The description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
receiving a quantum input signal at a reconfigurable quantum interface, wherein the reconfigurable quantum interface includes a plurality of nonlinear media each associated with a corresponding wavelength band and at least one quantum property;
selecting, via a switching device of the reconfigurable quantum interface, a nonlinear medium from among the plurality of nonlinear media for the quantum input signal;
tuning the nonlinear medium to produce a quantum output signal with a desired wavelength within the corresponding wavelength band and desired one or more quantum properties; and
converting, via the nonlinear medium, the quantum input signal to the quantum output signal with the desired wavelength and the desired one or more quantum properties.

2. The method of claim 1, wherein the desired wavelength of the quantum output signal corresponds to a wavelength for a wave-division multiplexing channel for a quantum network, and the at least one quantum property includes entanglement.

3. The method of claim 2, wherein the at least one quantum property further includes a lineshape.

4. The method of claim 1, wherein a combined wavelength band for the plurality of nonlinear media includes bandwidths for a series of different wave-division multiplexing channels of a quantum network.

5. The method of claim 1, wherein tuning the nonlinear medium uses a combination of thermal tuning and a second tuning technique including one of stress tuning and electro-optical tuning.

6. The method of claim 5, wherein the thermal tuning tunes the nonlinear medium in a coarse range, and the second tuning technique tunes the nonlinear medium in a narrower range with a higher tuning resolution.

7. The method of claim 1, wherein the nonlinear medium includes mineral or metallic materials.

8. The method of claim 1, wherein the nonlinear medium includes organic crystals.

9. The method of claim 1, wherein the quantum input signal is received from a quantum processor of a quantum network, and the method further comprises:
converting, via a second reconfigurable quantum interface, a second quantum input signal from a second quantum processor of the quantum network to a second quantum output signal with the desired wavelength and the desired one or more quantum properties;
sending the quantum output signal and the second quantum output signal to a network node of the quantum network; and
entangling the quantum processor and the second quantum processor at the network node based on the quantum output signal and the second quantum output signal, wherein the reconfigurable quantum interface, the second reconfigurable quantum interface, the quantum processor, the second quantum processor, and optical switches of the quantum network are synchronized utilizing one of time slots and command queues.

10. The method of claim 1, wherein the quantum input signal is received from a quantum processor of a quantum network, and the method further comprises:
routing, via a network node of the quantum network, the quantum output signal to a second quantum processor;
converting, via a second reconfigurable quantum interface, the quantum output signal to a second quantum output signal with a wavelength and one or more quantum properties compatible with the second quantum processor; and
entangling the quantum processor and the second quantum processor based on the second quantum output signal, wherein the reconfigurable quantum interface, the second reconfigurable quantum interface, the quantum processor, the second quantum processor, and optical switches of the quantum network are synchronized utilizing one of time slots and command queues.

11. An apparatus comprising:
a reconfigurable quantum interface including:
a plurality of nonlinear media each associated with a corresponding wavelength band and at least one quantum property;
a switching device to select a nonlinear medium from among the plurality of nonlinear media for a quantum input signal; and
a tuning mechanism to tune the nonlinear medium to convert the quantum input signal to a quantum output signal with a desired wavelength within the corresponding wavelength band and desired one or more quantum properties.

12. The apparatus of claim 11, wherein the desired wavelength of the quantum output signal corresponds to a wavelength for a wave-division multiplexing channel for a quantum network, and the at least one quantum property includes entanglement.

13. The apparatus of claim 11, wherein the at least one quantum property further includes a lineshape.

14. The apparatus of claim 11, wherein a combined wavelength band for the plurality of nonlinear media includes bandwidths for a series of different wave-division multiplexing channels of a quantum network.

15. The apparatus of claim 11, wherein the tuning mechanism uses a combination of thermal tuning and a second tuning technique including one of stress tuning and electro-optical tuning.

16. The apparatus of claim 15, wherein the thermal tuning tunes the nonlinear medium in a coarse range, and the second tuning technique tunes the nonlinear medium in a narrower range with a higher tuning resolution.

17. The apparatus of claim 11, wherein the nonlinear medium includes mineral or metallic materials.

18. The apparatus of claim 11, wherein the nonlinear medium includes organic crystals.

19. The apparatus of claim 11, wherein the quantum input signal is received from a quantum processor of a quantum network, and the apparatus further comprises:
a second reconfigurable quantum interface to convert a second quantum input signal from a second quantum processor of the quantum network to a second quantum output signal with the desired wavelength and the desired one or more quantum properties; and
a network node for the quantum network to entangle the quantum processor and the second quantum processor based on the quantum output signal and the second quantum output signal, wherein the reconfigurable quantum interface, the second reconfigurable quantum interface, the quantum processor, the second quantum processor, and optical switches of the quantum network are synchronized utilizing one of time slots and command queues.

20. The apparatus of claim 11, wherein the quantum input signal is received from a quantum processor of a quantum network, and the apparatus further comprises:
a network node for the quantum network to route the quantum output signal to a second quantum processor; and
a second reconfigurable quantum interface to convert the quantum output signal to a second quantum output signal with a wavelength and one or more quantum properties compatible with the second quantum processor to entangle the quantum processor and the second quantum processor, wherein the reconfigurable quantum interface, the second reconfigurable quantum interface, the quantum processor, the second quantum processor, and optical switches of the quantum network are synchronized utilizing one of time slots and command queues.
